(19) United States
(12) Patent Application Publication
(10) Pub. No.: US 2008/0215439 A1
(43) Pub. Date: Sep. 4, 2008

(54) Systems and Methods for Advancing Collections on Unpaid Debts

(76) Inventor: Blake L. Reynolds, Provo, UT (US)

Correspondence Address: Michael F. Krieger;KIRTON & McCONKIE, Suite 1800, 60 East South Temple, Salt Lake City, UT, 84111, US

(21) Appl. No.: 12/023,506

(22) Filed: Jan. 31, 2008

Related U.S. Application Data
(63) Continuation of application No. 10/039,905, filed on Jan. 4, 2002, now abandoned.

(51) Int. Cl. G06Q 30/00; G06Q 40/00

(52) U.S. Cl. 705/14

(57) ABSTRACT

Systems and methods for advancing collections on unpaid debts. Incentives that provide monetary and/or non-monetary rewards are utilized to encourage, promote, enable, and/or facilitate a collection of one or more unpaid accounts. A book of vouchers may be purchased for a letter-writing service, wherein the cost of the book is subtracted from monies collected. Rewards are allocated for providing unpaid accounts to a debt collection service. The eligibility for the receipt of rewards may require certification in accordance with the present invention. Collections are advanced in accordance with the present invention due to the incentives that encourage and promote collection efforts. Furthermore, improved relationships exist among entities involved in collecting the unpaid debts because of the increased incentives.

### CROSS-REFERENCE TO RELATED APPLICATIONS

This application is a continuation of prior application Ser. No. 10/039,905, filed Jan. 4, 2002.

### BACKGROUND OF THE INVENTION

1. Field of the Invention

The present invention relates to systems and methods for advancing collections on unpaid debts. More particularly, the present invention relates to systems and methods that encourage, promote, enable, and/or facilitate a collection of one or more unpaid accounts, and that provide monetary and/or non-monetary incentives for such collections.

2. Background and Related Art

Current business techniques exist that allow individuals or entities to be billed for services rendered. For example, a service provider (e.g., a doctor, dentist, lawyer, therapist, counselor, company, organization, professional, etc.) may perform a service to a recipient (e.g., patient, customer, client, entity, organization, etc.) and later bill the recipient for the service performed. Oftentimes, the bill is timely paid in full by the recipient to satisfy the debt. However, traditionally a percentage of all debts go unpaid or are difficult to collect. In such situations where the debts are unpaid or unsatisfied, techniques exist to attempt to collect on the unpaid debts.

Such debt collection techniques include the service provider contacting the recipients directly in order to collect on unpaid debts. While this technique may collect some debts, the process tends to be time consuming for the service provider. As such, representative entities (e.g., letter-writing agencies, collection agencies, attorneys, etc.) exist that will represent the service provider in contacting the recipients with the intention of collecting the unpaid debts. Such representative entities utilize various techniques to charge the service provider for the representation. Examples of the three typical techniques are flat fee, contingency, and factoring.

A first technique is to charge a flat fee. For example, a letter-writing agency may charge a service provider a flat fee (e.g., $10 for four or five letters) for letters sent to recipients that have unsatisfied debts owed to the service provider. The service provider typically pays the fee up front and the representative entity provides the letters to the recipients who owe the debts in an attempt to collect the monies owed. While this technique may collect on some debts owed, all of the debts are not typically collected in this manner. As such, the service provider often feels unsatisfied by having to pay in order to attempt to recover unpaid debts owed. Thus, service providers rarely repeat this effort.

A second technique includes a contingency fee arrangement between an agency (e.g., a collection agency) and the service provider. The contingency fee allows the agency to receive a percentage of all collections received on the unpaid debts. If none of the debts are collected, the service provider does not owe the agency any money. This eliminates the frustration of paying money for the attempt to collect bad debt, but because of the risk undertaken by the collection agency the percentage of the collection that would go to the agency is often quite high. Thus, this technique provides an incentive to the agency, but the portion of the collections that is ultimately received by the service provider is typically quite low in comparison with the amount of monies owed by the recipients. Furthermore, there is no guarantee that any portion of the debts owed will be collected.

A third technique includes an agency purchasing the unpaid debts or accounts from the service provider. While this technique ensures at least a partial recovery on all debts, the amount paid to purchase the unpaid debts is typically pennies on the actual dollar value of the unpaid debts. For example, an agency may pay 2% to 10% of the face value for the unpaid accounts. Thus, while the service provider does receive a portion of the unsatisfied debts, the portion received is low in comparison with the actual amount owed.

Thus, while traditional techniques exist to assist in collecting on unpaid debts, the techniques may require a prepayment by the service provider for debt collection efforts. Furthermore, any amount actually collected on the debts owed is typically small in comparison to the face value of the debt. Therefore, it would be an advantage in the art of debt collection to provide improvements to traditional techniques and/or to provide new methods that would encourage, promote, enable, and/or facilitate collections on debts owed.

### SUMMARY OF THE INVENTION

The present invention relates to systems and methods for advancing collections on unpaid debts. More particularly, the present invention relates to systems and methods that encourage, promote, enable, and/or facilitate a collection of one or more unpaid accounts, and that provide monetary and/or non-monetary incentives for such collections.

Implementation of the present invention takes place in association with an incentive methodology that provides monetary and/or non-monetary rewards in order to encourage, promote, enable, and/or facilitate the collection of one or more unpaid debts or accounts. In one implementation, a service provider may purchase a book of vouchers that may be redeemed during a particular period of time for debt collection efforts, such as letters written on behalf of the service provider to whom debt is owed. A minimum number of vouchers is required for purchase, but may be used by the service provider as desired until the vouchers expire. The vouchers may be prepaid, or may be subtracted from monies collected. Another implementation includes allocating monetary or non-monetary incentives to the service provider or a representative of the service provider (e.g., an office manager) for providing unpaid accounts to a debt collection service. In one implementation, a receipt of incentives requires certification.

Implementation of the present invention enables parties involved in collecting unpaid debts to receive monetary and/or non-monetary incentives, and advance collections on unpaid debts because the incentives and percentages encourage, enable, promote and/or facilitate a collection of at least a portion of one or more unpaid accounts. Furthermore, implementation yields improved relationships between entities involved in collecting the unpaid debts in comparison with traditional methods because of the increased incentives.

Methods and processes of the present invention may be performed through the utilization of one or more computer devices, in a variety of system configurations. Alternatively, the methods and processes may be performed without the use of a computer device.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that may be used in accordance with embodiments of the present invention;

FIG. 2 illustrates a representative system configuration that may be used in accordance with embodiments of the present invention;

FIG. 3 illustrates a flow chart that represents various collection phases for which a debt owed may undergo in order to be collected; and

FIG. 4 illustrates a flow chart that provides a representative method for encouraging, promoting, enabling, and/or facilitating the collection of one or more unpaid accounts in accordance with the present invention.

### DETAILED DESCRIPTION OF THE INVENTION

The present invention relates to systems and methods for advancing collections on unpaid debts. More particularly, the present invention relates to systems and methods that encourage, promote, enable, and/or facilitate a collection of one or more unpaid accounts, and that provide monetary and/or non-monetary incentives for such collections.

Embodiments of the present invention take place in association with an incentive methodology that provides monetary and/or non-monetary rewards in order to encourage, promote, enable, and/or facilitate the collection of one or more unpaid debts or accounts. In the disclosure and in the claims the term “reward” shall refer to any monetary and/or non-monetary benefit. Examples of such rewards include a percentage of monies collected, a commission payment, frequent flyer miles, credit or points that may be used toward the purchase of goods and/or services, and the like. Furthermore, in the disclosure and in the claims the term “service provider” shall refer to an individual, organization or entity that has performed a service or sold a product or good for value and has billed a recipient. Moreover, the term “recipient” shall refer to an individual, organization or entity that received a service, product or good and has been billed by the service provider or a representative thereof for the purchase of the service, product or good received.

The following disclosure of the present invention is grouped into three subheadings, namely “Utilization of a Representative System,” “Education and Certification of Debt Collection,” and “Encouraging Collection of Debts Owed.” The utilization of the subheadings is for convenience of the reader only and is not to be construed as limiting in any sense.

### Utilization of a Representative System

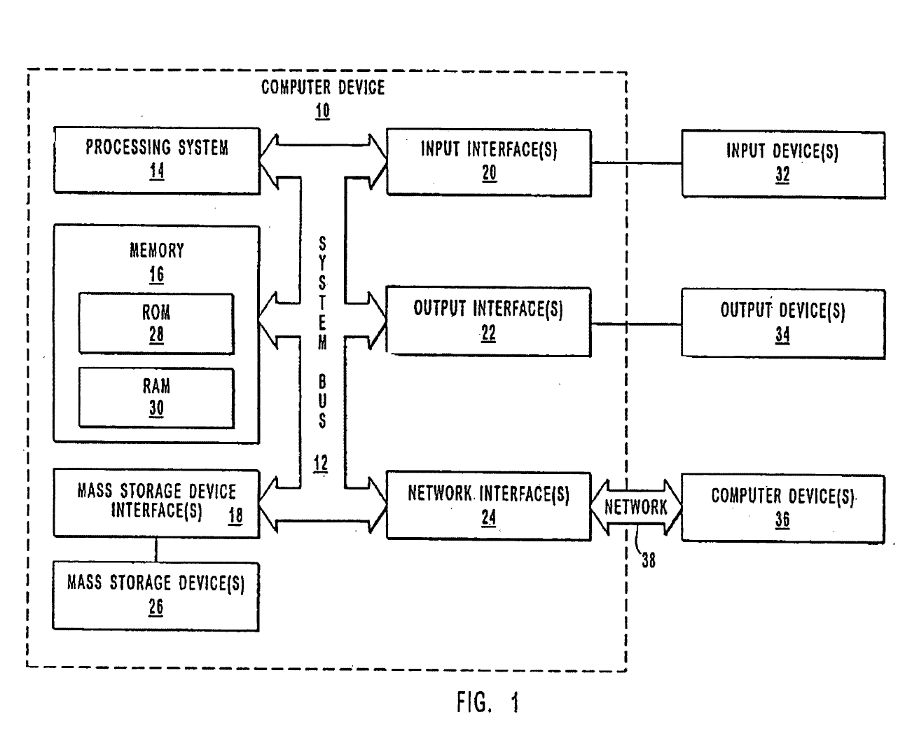

At least some of the embodiments of the present invention embrace the use of a computer device to implement methods and/or processes disclosed herein that may be used to encourage, promote, enable, track and/or facilitate the collection of one or more unpaid accounts or debts. As such, FIG. 1 and the corresponding discussion are intended to provide a general description of a computer device that may be used to implement such methods and/or processes. One skilled in the art will appreciate that embodiments of the present invention may be practiced by a variety of computing devices and/or in a variety of system configurations, including in a networked configuration.

At least some of the embodiments of the present invention embrace one or more computer readable media that may be used to implement such methods and/or processes disclosed herein, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods and/or processes disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), and any other device or component that is capable of providing data and/or executable instructions that may be accessed by a processing system.

With reference to FIG. 1, an illustration is provided of a representative system, which includes computer device 10, that may be used to implement such methods and/or processes to encourage, educate, promote, enable, track and/or facilitate the collection of one or more unpaid accounts or debts. In some embodiments of the present invention, computer device 10 is utilized to educate and/or certify one or more individuals in debt collection in accordance with the present invention, to track and/or allocate rewards for debt collection, and/or to encourage the collection of debts owed.

Computer device 10 may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods and/or processes disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

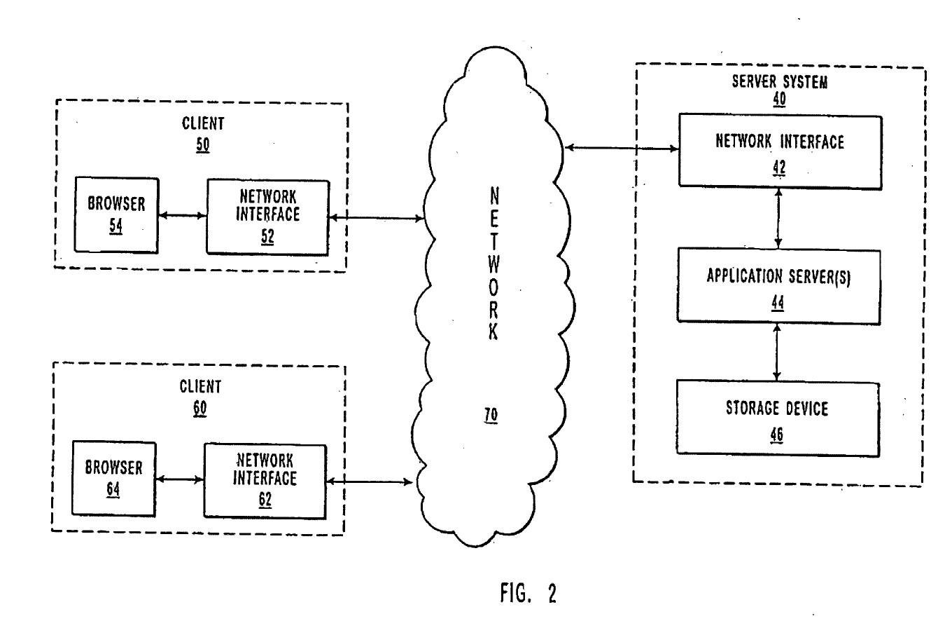

While those skilled in the art will appreciate that the invention may be practiced in networked computing environments with many types of computer system configurations, FIG. 2 represents an embodiment of the present invention that enables one or more client computer devices and/or one or more servers in a networked configuration to be used to implement methods and/or processes disclosed herein that may be used to encourage, promote, enable, track and/or facilitate the collection of one or more unpaid accounts or debts. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

In FIG. 2, server system 40 represents a system configuration that includes one or more servers that may be used to implement methods and/or processes disclosed herein to encourage, promote, educate, enable, track and/or facilitate the collection of one or more unpaid accounts or debts. For example, in one embodiment the one or more servers are used by a collection service that provides a service to a service provider for the collection of one or more unpaid accounts or debts. The service includes an apportionment of monetary and/or non-monetary rewards for providing and/or collecting of unpaid accounts. In a further embodiment, the one or more servers may be used in accordance with the present invention to educate an individual, agent or representative in collecting on unpaid accounts and/or in instructing on how monetary and/or non-monetary rewards may be obtained. Furthermore, the one or more servers may be used to certify the individual, agent or representative and qualify to receive monetary and/or non-monetary rewards. In one embodiment, the individual, agent or representative receives rewards for certifying. While FIG. 2 illustrates the use of a server system 40, those skilled in the art will appreciate that methods and/or processes of the present invention may be performed by the use of a single computer device or without the use of a computer device.

Thus, by way of example, server system 40 may be a single server in cases where a single server can process and preserve the entire amount of information required to perform the methods and systems of the present invention, as will be further explained below. Alternatively, server system 40 may be a conglomeration of servers that process and preserve a high volume of information.

The emergence of the Internet has enabled a very large number of computer devices across the world to be connected across a wide area network in order to participate in the utilization or exchange of information. The following is a discussion of an embodiment of the present invention that includes a plurality of clients, illustrated as clients 50 and 60, that are connected to server system 40 across the Internet, illustrated as network 70, in order to encourage, promote, enable, and/or facilitate a collection of one or more unpaid accounts.

With reference to FIG. 2, clients 50 and 60 each include a network interface (respectively illustrated as network interfaces 52 and 62) and a Web Browser (respectively illustrated as browsers 54 and 64). Network interface 52 is a communication mechanism that allows a client, such as client 50 to communicate to server system 40 by a network 70, such as the Internet. Browser 54 is an application program that allows information to be displayed on a monitor device as text and/or graphics in the form of a web page. A browser allows for the entering of uniform resource locator (“URL”) to thereby access the corresponding web page. Therefore, clients 50 and 60 may independently access a particular web page that may represent a collection service and/or may be used to educate on collection processes.

Server system 40 includes network interface 42, application servers 44, and storage device 46. Network interface 42 is a communication mechanism that allows server system 40 to communicate with one or more clients by a network 70. Application servers 44 include one or more servers for processing and/or preserving information, and may be employed for providing and maintaining a web page that enables the creation and/or utilization of a cognitive index. Storage device 46 includes one or more storage devices for preserving information, such as data, objects and/or other information to perform the methods enclosed herein. Storage device 46 may be internal or external to application servers 44.

Thus, a user (e.g., a service provider or representative thereof) or a program at one of the clients, such as client 50, may access a web page maintained by one or more of the application servers 44. While the discussion above has presented a representative system configuration that may be used to implement methods and/or processes of the present invention, those skilled in the art will appreciate that the methods of the present invention and processes thereof may be implemented in a variety of different system configurations.

### Education and Certification of Debt Collection

As provided above, at least some of the embodiments of the present invention embrace the use of computer systems that may be used in educating and/or certifying an individual, representative or entity. As such, the following disclosure of the present invention may be utilized in a system configuration that includes one or more computer devices as disclosed above, or may be utilized without a computer device.

Embodiments of the present invention embrace the use of incentives to encourage, promote, enable, and/or facilitate the collection of unpaid accounts or debts. In one embodiment, a certification program is provided that enables an individual to become educated and upon being certified qualifies the individual to begin to receive one or more rewards as incentives in accordance with the present invention. The understanding of debt collection and the various manners for receiving such incentives in accordance with the present invention encourages and enhances debt collection effort and performance.

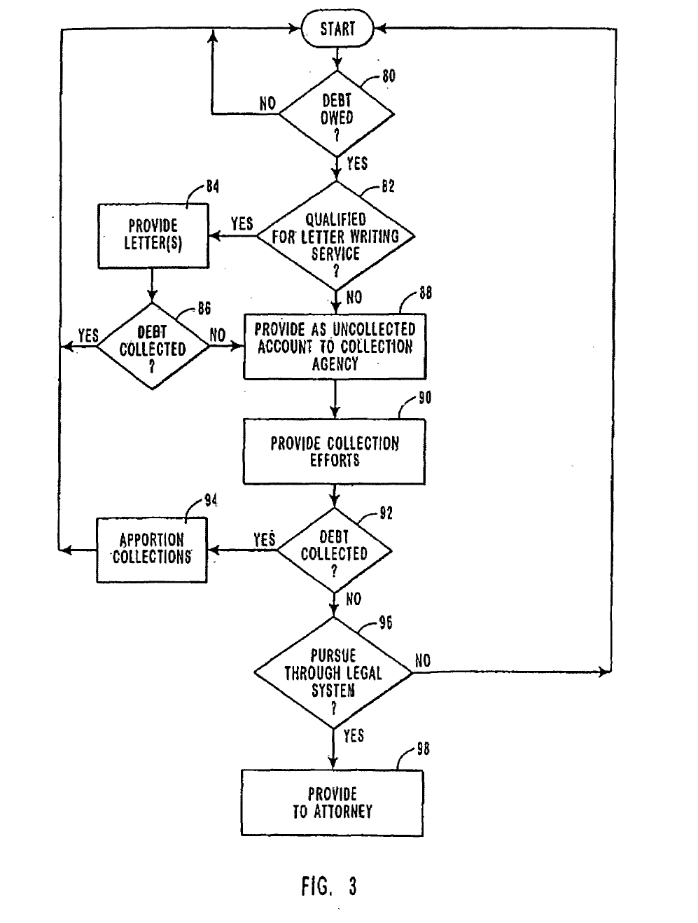

For example, with reference to FIG. 3, a flow chart is provided that illustrates various phases that a debt may undergo in order to be collected in accordance with the present invention. Such phases include a service, such as a letter-writing service, an agency, such as a collection agency, and the legal system.

Thus, in FIG. 3 execution begins at decision block 80 where a determination is made as to whether or not a debt is owed. If no debt is owed, execution returns back to start. Alternatively, if it is determined at decision block 80 that a debt is owed, execution proceeds to decision block 82 where a determination is made as to whether or not the debt qualifies for a service, such as a letter-writing service. Debts that do not qualify for a letter-writing service are such debts where the letter-writing service would prove to be ineffective, such as when the correct address is unknown, when the debt is old (e.g., has been established for over a year or some other extended time period), or when letters have already been sent in an attempt to collect the debt.

If it is determined at decision block 82 that the debt qualifies for a letter writing service, execution proceeds to step 84, wherein a letter writing service provides one or more letters as scheduled by the creditor of the debt. In one embodiment, a flat fee is charged for the letters provided at step 84. For example, a fee of $2.50 is charged per letter sent to collect the debt. In a further embodiment, in order to cause the process to be financially beneficial to the letter-writing agency, a minimum number (e.g., 10, 100, 1,000, etc.) of letter-writing vouchers must be purchased, wherein each voucher represents a number of letters that are to be prepared and sent by the letter-writing service. Thus, for example, if each voucher represented four letters and cost $10, and a minimum number of 100 vouchers had to be purchased, the service provider would pay the letter-writing agency $1,000 and the vouchers would expire after a certain period of time (e.g., after two years).

Execution then proceeds to decision block 86 for determination as to whether or not the debt was collected based on the letters provided. In one embodiment, the flat fee for the letters is extracted from monies collected as opposed to being prepaid to the letter-writing service and the rest of the monies collected are provided to the service provider to whom the recipient(s) owed the debt. Alternatively or additionally, a representative of the service provider may receive a reward for the business provided to the letter-writing agency. Thus, if it is determined at decision block 86 that at least a portion of the debt was collected, the monies collected may be appropriately allocated and execution returns back to start. Alternatively, if it is determined at decision block 86 that no part of the debt was collected based on the one or more letters provided at step 84, execution proceeds to step 88, where the debt is provided to a collection agency. Alternatively, if it is determined at decision block 82 that the debt does not qualifies for a letter writing service, execution proceeds directly to step 88.

At step 88 the debt is provided as an uncollected account to a collection agency. In one embodiment, a representative of the service provider receives one or more rewards for each uncollected account that is provided to a collection agency. Once provided, the collection agency provides or performs at step 90 the collection efforts in an attempt to collect the debt owed. Execution then proceeds to decision block 92 for determination as to whether or not at least a portion of the debt has been collected as a result of the efforts made by the collection agency. In one embodiment, a percentage of monies collected from the uncollected account is kept by the collection agency and the remaining portion is provided to the service provider.

Thus, if it is determined at decision block 92 that at least a portion of the debt has been collected, execution proceeds to step 94 for an apportionment of the monies collected on the debt and execution returns back to start. Alternatively, if it is determined at decision block 92 that no part of the debt has been collected as a result of the efforts made by the collection agency, execution proceeds to decision block 96.

At decision block 96 a determination is made as to whether or not to pursue collection of the debt through the legal system. If it is determined by the service provider (creditor) that the collection of the debt is not to be pursued through the legal system, execution returns back to start. Alternatively, if it is determined at decision block 96 that the collection of the debt is to be pursued through the legal system, execution proceeds to step 98, where the debt is provided to an attorney for collection.

### Encouraging Collection of Debts Owed

As provided above, embodiments of the present invention encourage, promote, enable, and/or facilitate a collection of one or more unpaid accounts. Such encouragement is enabled by the allocation of monies collected, the distribution of rewards, and/or education on debt collection and the rewarding processes disclosed herein. Furthermore, the encouragement facilitates relationships between a service provider who is owed a debt, a representative or manager, a sales agent, and a collection agency or service.

As provided above, a service provider who is owed a debt by a recipient may interface with a collection service or agency for assistance in collecting the debt. At times, a manager or representative represents the service provider. Furthermore, a sales representative may interface with the manager or service provider and the collection agency to bring the unpaid account owned by the service provider to the collection agency. In accordance with the present invention, each party may be appropriately rewarded, and thereby encouraged by rewards or incentives that may be obtained.

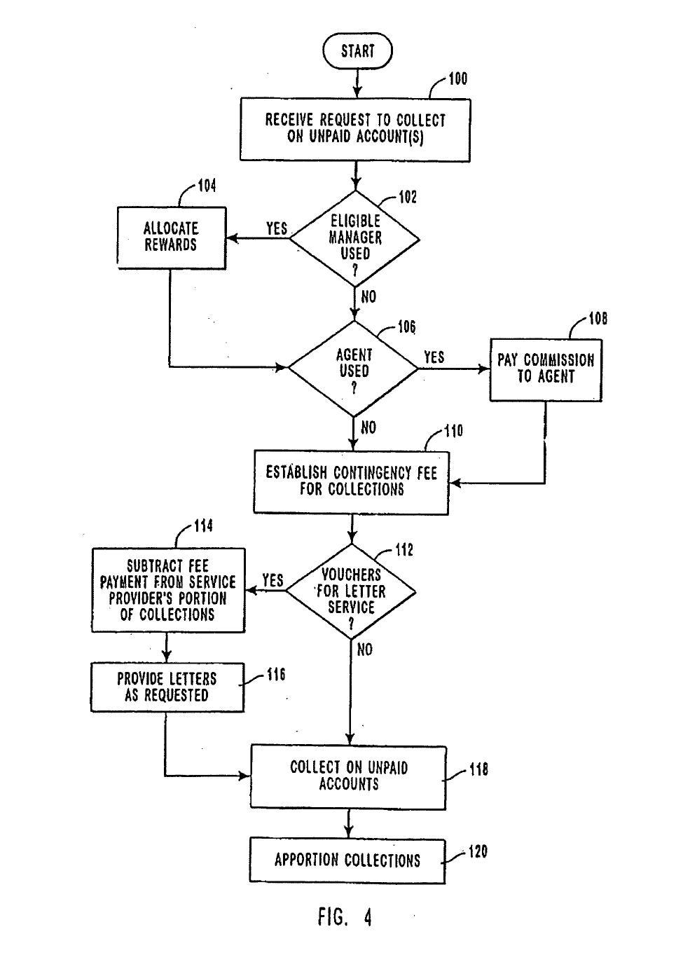

For example, with reference to FIG. 4, an embodiment is provided to illustrate the apportionment of rewards and/or monies collected in accordance with the present invention. In FIG. 4, execution begins at step 100 where a request is received to collect on unpaid accounts. (For example, accounts representing $100,000 owed to a particular service provider.) In one embodiment, the receipt of a request to collect on one or more unpaid accounts is performed electronically. For example, a software application provides a link to an account management software application that is used by the service provider. The service provider uses the account management software to manage the accounts for services billed to recipients. At the conclusion of a preset period of time (e.g., 90 days) from when the service was performed, if the account has not been paid in full the link automatically provides an electronic request to a collection agency or another entity to collect on the unpaid account. A notification of the transmission of the request may also be provided to the service provider. As such, the link is used to automatically provide requests to collect on unpaid accounts.

Once the request is received at step 100, a determination is made at decision block 102 as to whether or not an eligible manager or representative was used by the service provider. In one embodiment, a manager is eligible when that manager has become certified in accordance with the present invention and thus becomes eligible for receipt of rewards. For example, as provided above, a manager or representative may be educated as to collection procedures and upon receiving the education may be certified in accordance with the present invention. In a further embodiment, the rewards are received for unpaid accounts provided. In one embodiment, the rewards allocated are based on the quantity of monies owed (i.e., more points/rewards are provided for larger unpaid accounts) and/or the age of the unpaid accounts (i.e., more points/rewards are provided for more recently established unpaid accounts).

Thus, if it is determined at decision block 102 that an eligible manager was used to provide the account(s) at step 100, execution proceeds to step 104 where the rewards are appropriately allocated. Execution then proceeds to decision block 106. Alternatively, if it is determined at decision block 102 that an eligible manager was not utilized, execution proceeds directly to decision block 106.

At decision block 106, a determination is made as to whether or not an agent (e.g., a sales representative) representing the collection agency was utilized to obtain the unpaid account(s) at step 100. In one embodiment, the agent is paid a commission (e.g., 0.5% of the face value of the unpaid accounts) by the collection agency for having brought the unpaid account to the agency for collection. In a further embodiment, the commission paid corresponds to the dollars represented by the unpaid accounts, the number of accounts, the age of the accounts, and/or the ability to collect on the accounts. Thus, if it is determined at decision block 106 that an agent was utilized, execution proceeds to step 108 where the commission is paid to the agent and then to step 100. Alternatively, if it is determined at decision block 106 that an agent was not used, execution proceeds directly to step 110.

At step 110 the contingency fee or apportionment is established for collections on the unpaid accounts. For example, it may be determined that for the $100,000 represented by the unpaid accounts provided at step 100, the service provider who is owed the money will receive 75% of all monies collected and the collection agency will receive the remaining 25%. In a further embodiment, the percentages vary depending on various characteristics, such as the face value of the accounts, the number of accounts, and/or the ability to collect on the accounts (e.g., age of the accounts, etc.). Furthermore, the percentages may be different from account to account.

At decision block 112 a determination is made as to whether or not vouchers are purchased for a letter writing service. For example, in the illustrated embodiment, a fee charged for letter-writing vouchers is subtracted from the service provider's portion of the monies collected rather than requiring prepayment. Moreover, in one embodiment, 100% of all monies collected from the efforts of a letter-writing service are paid to the service provider (creditor) to whom the debt was owed. Thus, if it is determined at decision block 112 that the vouchers were purchased, execution proceeds at step 114, wherein it is established that the fee payment for the vouchers is to be subtracted from the service provider's (creditor's) portion of monies collected. Execution then proceeds to step 116 where the letters are provided as requested by the professional. In one embodiment, the letters may be provided over a period of time. Execution then proceeds to step 118. Alternatively, if it is determined at decision block 112 that the vouchers are not purchased by the professional, execution proceeds directly to step 118.

At step 118 the collection agency performs collection procedures or services on the unpaid accounts provided at step 100. As shall be appreciated by those skilled in the art, a variety of collection procedures may be performed. For example, FIG. 3 and the corresponding discussion above provide representative collection procedures, including a letter writing service to collect on debts owed. As a result of the procedures or services performed at step 100, a percentage of the face value of the unpaid account(s) is obtained. For example, if the face value of the unpaid accounts of step 100 was $100,000 and 80% of the monies were collected by the collection agency, $80,000 would have been collected. (The percentage provided is only illustrative and those skilled in the art will appreciate that a variety of factors, such as the age of the accounts and other such factors, affect the ability to collect monies owed.) Execution then proceeds to step 120, where the monies collected at step 118 are appropriately apportioned in accordance with the present invention.

Thus, in accordance with the present example, the service provider is apportioned 75% of the monies collected ($80,000) minus the $1000 for payment of the letter writing vouchers, if purchased. As such, the service provider is apportioned a total of $59,000, and receives 100% of the total amount of monies collected by the letter-writing service. The letter-writing service receives the fee charged for the vouchers. The collection agency receives 25% of the monies collected ($80,000) minus any commission fee that is paid to a sales representative (e.g., $500, which under the present example is 0.5% of the $100,000 face value amount). As such, the collection agency receives $19,500. Furthermore, as provided above, the office manager representing the service provider receives various points/rewards for the unpaid accounts that were provided to the collection agency.

Therefore, since each of the parties involved in collecting on unpaid debts may receive monetary and/or non-monetary incentives, embodiments of the present invention advance collections on unpaid debts because the incentives and percentages encourage, promote, enable, and/or facilitate a collection of one or more unpaid accounts. Furthermore, implementation of the present invention yields improved relationships between the parties involved in collecting the debts in comparison with traditional methods because of the increased incentives, efforts, and performances in collecting on unpaid debts.

Thus, as discussed herein, the embodiments of the present invention embrace systems and methods for advancing collections on unpaid debts. In particular, the present invention relates to systems and methods that encourage, promote, enable, and/or facilitate a collection of one or more unpaid accounts, and that provide monetary and/or non-monetary incentives for such collections. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method for encouraging the presentation by a business of a series of unpaid debts to a collection agency, the method comprising the steps of:
sending a request to the collection agency to collect on an unpaid debt;
the collection agency rewarding the business providing the unpaid debt, wherein the reward given to the business from the collection agency includes a non-monetary incentive provided based on a characteristic of the unpaid debt;
the collection agency selectively performing one or more debt collection procedures to collect at least a portion of the unpaid debt of the business; and
selectively apportioning between the business and the collection agency the portion of the unpaid debt that has been collected.

2. A method as recited in claim 1, wherein the step of the collection agency rewarding the business providing the unpaid dept comprises the steps of:
determining eligibility for receipt of the reward; and
if eligibility exists, allocating the reward.

3. A method as recited in claim 2, wherein eligibility occurs upon education and certification in at least one of:
(i) one or more debt collection techniques; and
(ii) one or more techniques to receive rewards for unpaid debts.

4. A method as recited in claim 3, wherein a reward is provided upon certification.

5. A method as recited in claim 3, wherein a computer device is employed to perform at least one of the steps of:
(i) receiving the request, wherein the request is an electronic request; and
(ii) providing the education.

6. A method as recited in claim 3, wherein the reward includes credit for use in obtaining at least one of:
(i) a good; and
(ii) a service.

7. A method as recited in claim 6, wherein the credit includes a frequent flyer mile.

8. A method as recited in claim 1, wherein the step for selectively apportioning comprises the steps of:
identifying a debt owner's amount of the portion collected, wherein the debt owner's amount is the amount of the portion that is to be provided to a service provider to whom the unpaid debt is owed; and
identifying a collection entity's amount of the portion collected, wherein the collection entity's amount is to be provided to an entity that performed the debt collection procedures.

9. A method as recited in claim 8, further comprising the steps of:
determining whether one or more letter-writing vouchers are desired; and
if the vouchers are desired, subtracting a payment for the vouchers from the debt owner's amount prior to providing the debt owner's amount to the service provider to whom the unpaid debt is owed.

10. A method as recited in claim 9, wherein the vouchers include a book of vouchers that comprises a minimum number of vouchers required for purchase.

11. A method for advancing the presentation of unpaid debts for collection, the method comprising the steps of:
sending a request to a collection agency to collect on an unpaid debt;
certifying an individual upon being educated in debt collection procedures to receive a reward for providing at least one in a series of unpaid debts to a collection entity, wherein the reward includes one or more non-monetary incentives;
providing the reward to the certified individual upon providing the unpaid debt to the collection entity.

12. The method as recited in claim 11, wherein the step of certifying comprises the step of providing education relating to at least one of:
(i) debt collection; and
(ii) an incentive program that includes the non-monetary incentives.

13.-23. (canceled)
